(19) United States
(12) Patent Application Publication
(10) Pub. No.: US 2024/0281583 A1
(43) Pub. Date: Aug. 22, 2024

(54) METHOD AND DEVICE FOR TIMING CORRECTION, COMPUTING DEVICE AND STORAGE MEDIUM

(71) Applicant: ShenZhen Huada Empyrean Technology Co., Ltd., Guangdong (CN)

(72) Inventors: Yi Liu, Guangdong (CN); Jingjing FU, Guangdong (CN); Bin Chen, Guangdong (CN); Senhua Dong, Guangdong (CN)

(21) Appl. No.: 18/294,233

(22) PCT Filed: Mar. 29, 2022
(86) PCT No.: PCT/CN2022/083525

§ 371 Date: Feb. 1, 2024

(30) Foreign Application Priority Data
Aug. 19, 2021 (CN) 202110952814.5

(51) Int. Cl. G06F 30/3315; G06F 30/3323

(52) U.S. Cl. CPC G06F 30/3315; G06F 30/3323

(57) ABSTRACT

A method and a device for timing correction, a computing device, and a storage medium applied to an integrated circuit are provided. In the method, the integrated circuit includes normal logic cells and spare correction cells, determining a timing path with a timing error and a first normal logic cell in the timing path that does not meet a timing requirement in the integrated circuit; setting a search range around the first normal logic cell and determining at least one spare correction cell within the search range; testing and obtaining a timing result of the at least one spare correction cell used in the integrated circuit; determining a target spare correction cell according to the timing result, wherein the target spare correction cell is at least one of the at least one spare correction cell. The method for timing correction and etc. ensure the correctness of the chip design.

### CROSS-REFERENCE TO RELATED APPLICATION

This application is a Section 371 National Stage application of International Application No. PCT/CN2022/083525, which was filed on Mar. 29, 2022 and published as WO 2023/019954 A1 on Feb. 23, 2023, and claims priority to the Chinese Patent Application No. 2021109528145, filed on Aug. 19, 2021, entitled “METHOD AND DEVICE FOR TIMING CORRECTION, COMPUTING DEVICE AND STORAGE MEDIUM”, the contents of which are incorporated herein by reference in their entireties.

### BACKGROUND OF THE DISCLOSURE

### Field of Technology

The present disclosure relates to a technical field of electronic design automation (EDA), and in particular, to a method and a device for timing correction, a computing device and a storage medium.

### Description of the Related Art

In digital integrated circuit design, in order to ensure that a chip works normally and reaches an expected frequency, it is necessary to check whether the time for a clock signal and a data signal to reach a synchronization register meets requirements of setup time and hold time. If a timing violation is occurred and detected at an early design phase, a right to left (RTL) code could be modified in an early design: however, an engineering change order (ECO) is required to correct timing violation if a timing violation is detected at a later design phase.

Generally, ECO for correcting timing could be divided into two types: before signing off and taping out (pre-mask) and after signing off and taping out (post-mask). Pre-mask ECO has great flexibility. If a timing error is found before taping out, timing optimization could be performed using common methods, such as inserting buffer unit, changing cell size, splitting large wire mesh, etc. In a late stage of chip design, especially after signing off and taping out, a layout of a standard unit has been fixed and cannot be changed, and important chip layers such as M1 metal layer and polysilicon layer cannot be changed. At this time, if there is a timing error in a key path, the layout cannot be modified and new logic units cannot be added, and only an upper metal connection could be changed to adjust and remedy the timing.

Therefore, a new method and a device for timing correction, a computing device and a storage medium applied to integrated circuits are desired to perform timing correction in the post-mask stage of the later design phase without changing the physical layout of the chip.

### SUMMARY OF THE INVENTION

In view of the above problems, an objective of the present disclosure is to provide a method for timing correction and a device, a computing device and a storage medium, so that timing correction could be performed in a post-mask stage of a later design phase to ensure a correctness of a chip design.

According to an aspect of the present disclosure, a method for timing correction applied to an integrated circuit is provided. The integrated circuit includes a plurality of normal logic cells and a plurality of spare correction cells. The method for timing correction includes: determining a timing path with a timing error and a first normal logic cell in the timing path that does not meet a timing requirement in the integrated circuit: setting a search range around the first normal logic cell and determining at least one spare correction cell for timing correction within the search range: testing one by one and obtaining a timing result of the at least one spare correction cell for timing correction used in the integrated circuit; determining a target spare correction cell for timing correction in the integrated circuit according to the timing result, wherein the target spare correction cell is at least one of the at least one spare correction cell for timing correction.

Preferably, the method for timing correction further includes: obtaining a cell type and a physical position of the first normal logic cell.

Preferably, setting a search range around the first normal logic cell includes: setting a distance parameter: determining that the search range is within a Manhattan distance of the first normal logic cell and the distance parameter.

Preferably, the method for timing correction further includes: searching for a spare cell in the search range, and determining a target spare cell according to the spare cell: modifying a wire network connection according to the target spare cell.

Preferably, the method for timing correction further includes: searching for a filler cell in the search range, wherein a width of the filler cell is larger than a width of a buffer cell: determining a target buffer cell according to the buffer cell: modifying a wire network connection according to the target buffer cell, wherein the method for timing correction further includes back-filling at least one filler cell.

Preferably, setting a search range around the first normal logic cell includes: setting a distance parameter; traversing a combined logic cell on a timing violation path; determining that the search range is within a Manhattan distance of the combined logic cell and the distance parameter.

Preferably, the method for timing correction further includes: searching for a spare cell that is functionally consistent with the first normal logic cell in the search range, and determining a target spare cell according to the spare cell: modifying a wire network connection according to the target spare cell.

Preferably, the method for timing correction further includes: searching for a filler cell in the search range, wherein a width of the filler cell is larger than a width of a functional cell: searching for the functional cell that is functionally consistent with the first normal logic cell: deleting an original filler cell and determining a target functional cell according to the functional cell; modifying a wire network connection according to the target functional cell, wherein the method for timing correction further includes back-filling at least one filler cell.

According to another aspect of the present disclosure, a device for timing correction of an integrated circuit is provided. The integrated circuit includes a plurality of normal logic cells and a plurality of spare correction cells. The device for timing correction includes a violation determination unit, a search unit, a test unit and a target determination unit. The violation determination unit is configured to determine a timing path with a timing error and a first normal logic cell in the timing path that does not meet a timing requirement in the integrated circuit. The search unit is configured to set a search range around the first normal logic cell and determining at least one spare correction cell for timing correction within the search range. The test unit is configured to test one by one and obtaining a timing result of the at least one spare correction cell for timing correction used in the integrated circuit. The target determination unit is configured to determine a target spare correction cell for timing correction in the integrated circuit according to the timing result, wherein the target spare correction cell is at least one of the at least one spare correction cell for timing correction.

According to a further aspect of the present disclosure, a computing device is provided and includes: a processor: a memory for storing one or more programs, wherein, when the one or more programs are executed by the processor, the processor performs a method for timing correction according to embodiments of the present disclosure.

According to a further aspect of the present disclosure, a computer-readable storage medium storing a computer program is provided, wherein the method for timing correction according to embodiments of the present disclosure is performed when the program is executed by a processor.

According to the method for timing correction and the device, the storage medium and the memory medium applied to the integrated circuit of the embodiment of the disclosure, by use of the spare correction cell, a mental layer connection is changed to achieve a purpose of timing optimization without changing a principle of maintaining a base layer of a physical layout of chip design unchanged, so that timing correction could be performed in the post-mask stage of the later design phase to ensure the correctness of the chip design.

According to the method for timing correction and the device, the storage medium and the memory medium according to embodiments of the present disclosure, timing optimization operations, such as buffer cell insertion and combined logic cell size change, is realized by Spare cell and GA cell without changing the base layer and the circuit function of the chip, so as to correct timing violation and ensure the normal operation of the chip.

According to the method for timing correction and the device, the storage medium and the memory medium according to embodiments of the present disclosure, a way of timing correction and the spare correction cell could be flexibly selected, with a wide range of application and a good correction effect.

### BRIEF DESCRIPTION OF THE DRAWINGS

Through following description of the embodiments of the present disclosure with reference to accompanying drawings, the above and other objectives, features, and advantages of the present disclosure will be more apparent, in the accompanying drawings:

FIG. 1 shows a method flow chart of a method for timing correction according to an embodiment of the present disclosure;

FIG. 2 shows a method flow chart of a method for timing correction according to an embodiment of the present disclosure;

FIG. 3 shows a schematic diagram of chip layout according to an embodiment of the present disclosure;

FIG. 4 shows a schematic diagram of timing correction according to an embodiment of the present disclosure;

FIG. 5 shows a method flow chart of a method for timing correction according to an embodiment of the present disclosure;

FIG. 6 shows a filler cell and a functional cell of different widths according to the embodiment of the present disclosure;

FIG. 7 shows a schematic diagram of timing correction according to an embodiment of the present disclosure;

FIG. 8 shows a method flow chart of a method for timing correction according to an embodiment of the present disclosure;

FIG. 9 shows a schematic diagram of timing correction according to an embodiment of the present disclosure;

FIG. 10 shows a method flow chart of a method for timing correction according to an embodiment of the present disclosure;

FIG. 11 shows a schematic diagram of timing correction according to an embodiment of the present disclosure;

FIG. 12 shows a schematic diagram of a device for timing correction according to an embodiment of the present disclosure;

FIG. 13 shows a schematic diagram of a computing device according to an embodiment of the present disclosure.

### DETAILED DESCRIPTION OF THE DISCLOSURE

Various embodiments of the present disclosure will be described in more detail below with reference to accompanying drawings. In each drawing, same elements are represented by a same label or similar reference labels. Sections in the accompanying drawings are not plotted to scale for clarity. Furthermore, some publicly known parts may not be shown in the drawings.

The specific embodiments of the disclosure are described further in detail in combination with the drawings and embodiments. Many specific details of the disclosure, such as component structure, material, sizes, treatment processes, and techniques, are described below in order to provide a clearer understanding of the disclosure. However, as those skilled in the art can understand, the present disclosure may not be implemented according to these specific details.

It should be understood that when describing the structure of a part, when a layer or one area is called “on” or “above” another layer, it may be directly on another layer or another area, or containing another layer or area between it and another layer or another area. And, if the part is flipped, that layer, one area, will be located “under” or “below” in another layer, or in another area.

According to an aspect of the present disclosure, a method for timing correction applied to an integrated circuit is provided. The integrated circuit includes a plurality of normal logic cells and a plurality of spare correction cells. The method for timing correction according to an embodiment of the present disclosure is a method for timing correction which can be applied after signing off and taping out (post-mask).

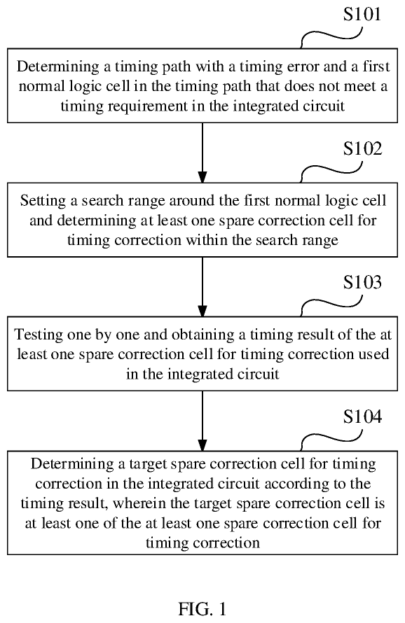

FIG. 1 shows a method flow chart of a method for timing correction according to an embodiment of the present disclosure. As shown in FIG. 1, the method for timing correction according to the embodiment of the present disclosure includes following steps.

Step S101: determining a timing path with a timing error and a first normal logic cell in the timing path that does not meet a timing requirement in the integrated circuit.

Determine the timing path with the timing error and the first normal logic cell in the timing path that does not meet the timing requirement in the integrated circuit. For example, determine the timing path (Path A) with the timing error, and find the first normal logic cell (timing violation cell, Cell A) requiring timing correction.

Step S102: setting a search range around the first normal logic cell and determining at least one spare correction cell for timing correction within the search range.

Set the search range around the first normal logic cell and determine at least one spare correction cell for timing correction within the search range. For example, a certain area is set as the search range with the first normal logic cell as a center, and a spare correction cell could be used for timing correction is searched within the search range. Optionally, the spare correction cell includes a buffer cell and/or a logic cell.

Step S103: testing one by one and obtaining a timing result of the at least one spare correction cell for timing correction used in the integrated circuit.

Test one by one and obtaining the timing result of the at least one spare correction cell for timing correction used in the integrated circuit. For example, timing violation is corrected respectively according to the correction cells found within the search range, a corrected new timing (timing result) is evaluated, and the correction cell without timing violation is added in an alternative scheme. Optionally, performing timing correction according to the correction cell could be replacing the first common logic cell with the correction cell, connecting the correction cell in a timing violation path, or other correction methods.

Step S104: determining a target spare correction cell for timing correction in the integrated circuit according to the timing result, wherein the target spare correction cell is at least one of the at least one spare correction cell for timing correction.

Determine the target spare correction cell for timing correction in the integrated circuit according to the timing result, wherein the target spare correction cell is at least one of the at least one spare correction cell for timing correction. For example, all the alternative schemes (that is, among all spare correction cell without timing violation in the search range) are compared, and a most suitable spare correction cell is selected as the target spare correction cell. Optionally, all the alternative schemes are traversed, to find a most optimal scheme to improve the timing, so as to realize timing violation correction of the timing path. Optionally, the target spare correction cell could be the closest one of the spare correction cells to the first normal logic cell, or having the shortest line for a required modification, or the spare correction cell of a specific cell type.

In an alternative embodiment of the present disclosure, the method for timing correction further includes acquiring the cell type and the physical position of the first normal logic cell. For example, determine the timing path with timing violation, and find the first normal logic cell requiring timing correction: obtain the cell type and the physical position of the first normal logic cell. For example, determine the physical position (Xₐ, Yₐ) of the first normal logic cell on the chip.

In an alternative embodiment of the present disclosure, setting the search range around the first normal logic cell includes: setting a distance parameter; with the first normal logic cell as the center, determining that the search range is within a Manhattan distance of the first normal logic cell and the distance parameter. Optionally, the distance parameter (a parameter dist of distance range) is determined, and the search range is determined within the Manhattan range of {|X-Xa|<dist, |Y-Ya|<dist} with the first normal logic cell (Cell A) as the center. For example, the above steps are used for an engineering change order (ECO) operation of buffer cell insertion.

In an alternative embodiment of the present disclosure, setting the search range around the first normal logic cell includes: setting a distance parameter; traversing a combined logic cell on a timing violation path: determining that the search range is within a Manhattan distance of the combined logic cell and the distance parameter. Optionally, the combined logic cell C on the timing path Path A is traversed, the distance parameter (a parameter dist of a distance range) is determined, and the search range is determined within the Manhattan range of {|X-Xc|<dist, |Y-Yc|<dist}. For example, the above steps are used for an ECO operation of size changing of combined logic cell.

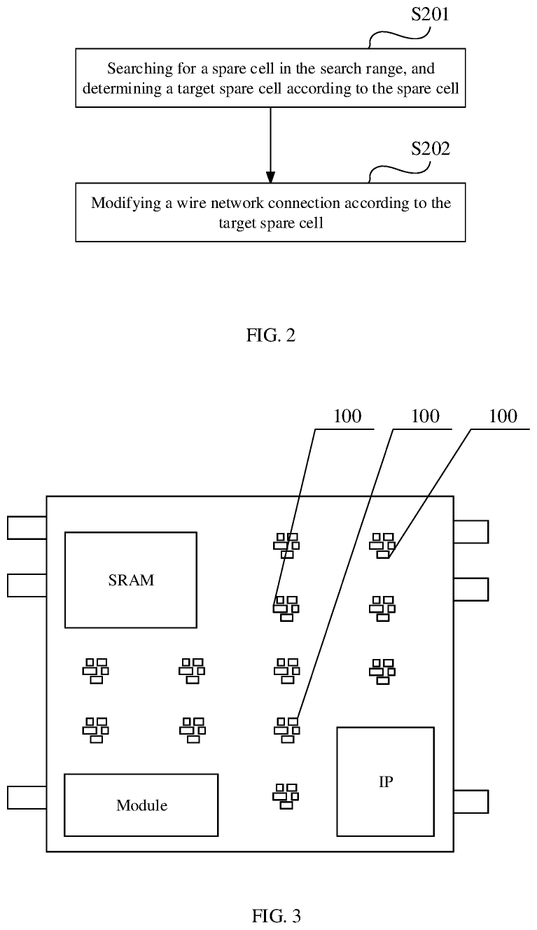

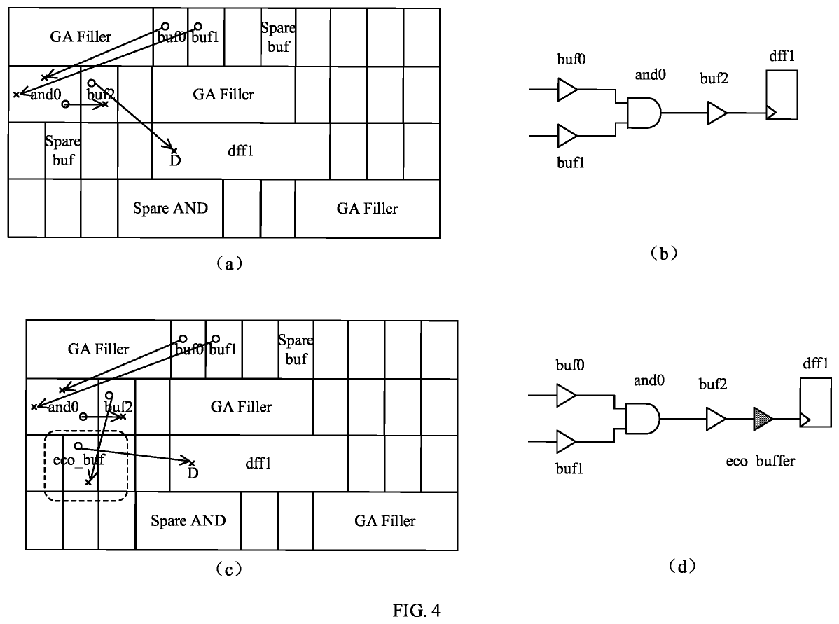

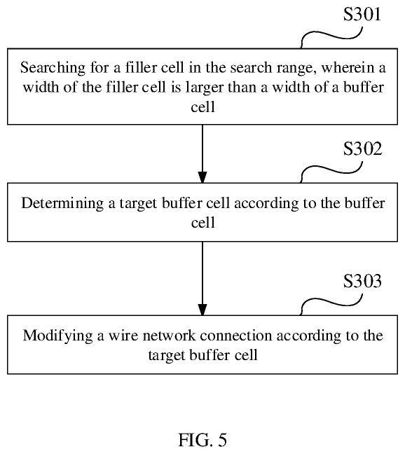

FIG. 2 shows a method flow chart of a method for timing correction according to an embodiment of the present disclosure. FIG. 3 shows a schematic diagram of chip layout according to an embodiment of the present disclosure. FIG. 4 shows a schematic diagram of timing correction according to an embodiment of the present disclosure.

As shown in FIG. 3, spare cells (denoted as Spare) 100 are randomly arranged on the chip layout for use in the ECO stage. With reference to FIGS. 2, 3 and 4, the method for timing correction according to an embodiment of the disclosure includes following steps.

Step S201: searching for a spare cell in the search range, and determining a target spare cell according to the spare cell.

By searching for the spare cell in the search range, the target spare cell can be determined according to the spare cell. Optionally, by finding (all) spare cells that could perform timing correction within the determined search range, and a most suitable spare cell for correcting timing violation is selected from the found spare cells as the target spare cell.

Step S202: modifying a wire network connection according to the target spare cell.

The wire network connection is modified according to the target spare cell. The wire network connection is modified to correct timing violation according to the target spare cell which is finally determined. Specifically, the spare cells (denoted as Spare) are some additional spare logic gates inserted in a physical design stage, such as buffer, inverter, AND gate, OR gate, NAND gate, NOR gate, etc. The logic function can be realized as a buffer cell by providing input pins with high voltage level or low voltage level. They have no functional logic in an original circuit, and are randomly arranged on the chip layout at the beginning when a netlist file is read, for possible use in the ECO stage.

In an alternative embodiment of the present disclosure, figure (a) of FIG. 4 shows the layout with timing violation, figure (b) of FIG. 4 shows a circuit structure of timing violation, figure (c) of FIG. 4 shows the layout after performing timing correction, and figure (d) of FIG. 4 shows a circuit structure after performing timing correction. FIG. 4 shows the ECO operation of buffer cell insertion by use of the spare cell (Spare) according to an embodiment of the present disclosure. As shown in FIG. 4, when the timing violation occurs, the path and cell with timing violation are determined. Then search for the spare cell and select the target spare cell (that is, eco_buffer in Figure (d) of FIG. 4). Modify wire network connection according to the final target spare cell.

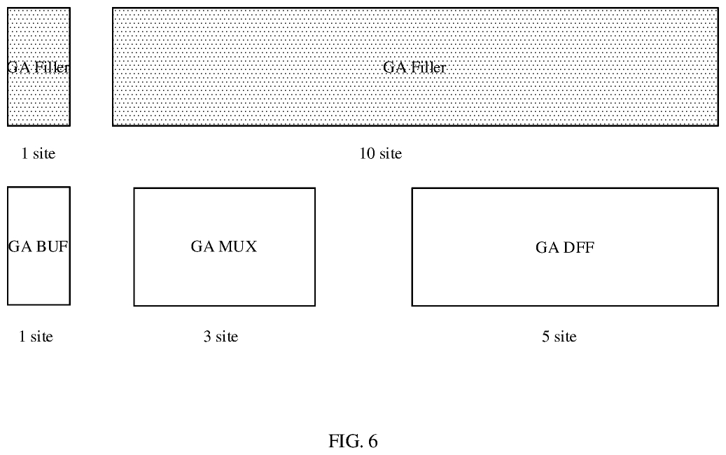

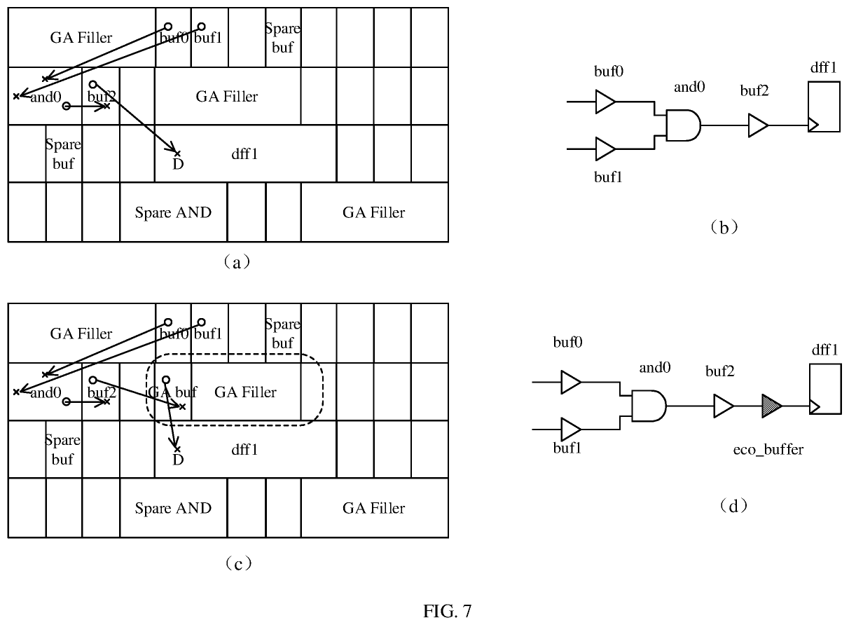

FIG. 5 shows a method flow chart of a method for timing correction according to an embodiment of the present disclosure. FIG. 6 shows a filler cell and a functional cell of different widths according to the embodiment of the present disclosure. FIG. 7 shows a schematic diagram of timing correction according to an embodiment of the present disclosure. With reference to FIGS. 5, 6 and 7, the method for timing correction according to an embodiment of the disclosure includes the following steps.

Step S301: searching for a filler cell in the search range, wherein a width of the filler cell is larger than a width of a buffer cell.

Search for the filler cell (GA filler) in the search range, wherein the width of the filler cell (GA filler) is larger than the width of the buffer cell (GA Buffer).

Step S302: determining a target buffer cell according to the buffer cell.

Determine a target buffer cell according to the buffer cell. For example, a most suitable GA buffer for correcting timing violation is selected from the all GA buffers as the target GA buffer cell.

Step S303: modifying a wire network connection according to the target buffer cell.

Modify the wire network connection according to the target buffer cell.

Optionally, the line network connection is modified to correct timing violations according to the final GA Buffer. Specifically, GA (Gate Array) cells could be divided into GA fillers, GA functional cells, GA Cap capacitive cells and other types. In addition to filling a gap between the cells after the layout wiring is completed, it can also solve the problems of a base layer and a bottom metal layer density and reduce an IR drop voltage drop. They vary in width, usually as an integer multiple of the cell row site. GA filler is only defined in LEF with no timing function, which only acts as the role of map filling space. In the ECO stage, the GA filler will be replaced with the GA functional cell to realize the corresponding logical functions, such as logics of AND, OR and NOT, and multiple selection, etc.

In an alternative embodiment of the disclosure, the method for timing correction further includes back-filling at least one filler cell (GA filler) to ensure that no gaps appear on the cell line.

In an alternative embodiment of the present disclosure, figure (a) of FIG. 7 shows the layout with timing violation, figure (b) of FIG. 7 shows a circuit structure of timing violation, figure (c) of FIG. 7 shows the layout after performing timing correction, and figure (d) of FIG. 7 shows a circuit structure after performing timing correction. FIG. 7 shows the ECO operation of buffer cell insertion by use of a GA buffer according to an embodiment of the present disclosure. As shown in FIG. 7, when the timing violation occurs, the path and the cell with timing violation are determined. Then search for the GA buffer and select the target buffer cell (that is, eco_buffer in Figure (d) of FIG. 7). Modify wire network connection according to the final target buffer cell.

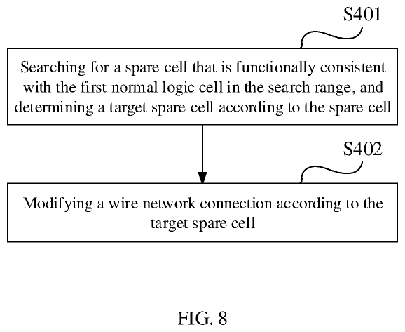

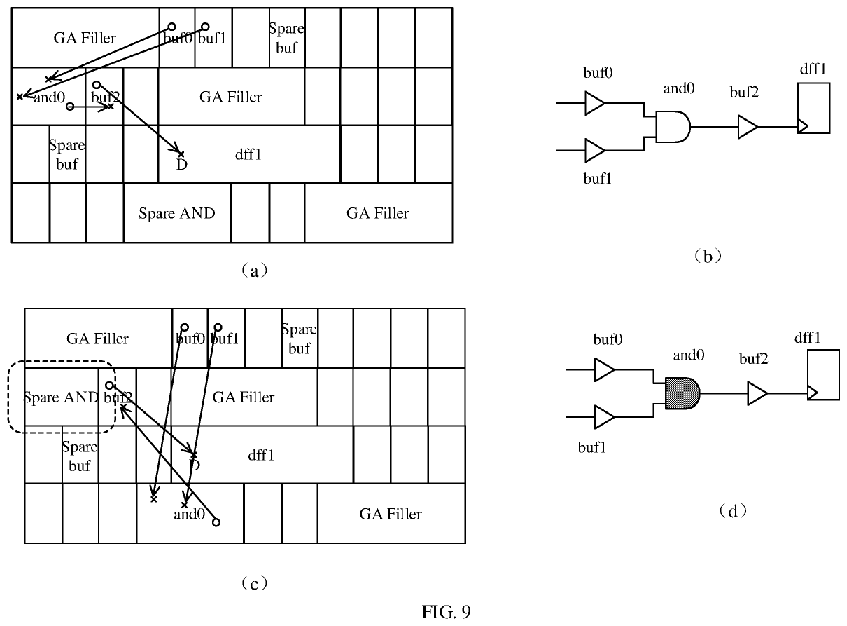

FIG. 8 shows a method flow chart of a method for timing correction according to an embodiment of the present disclosure. FIG. 9 shows a schematic diagram of timing correction according to an embodiment of the present disclosure. As shown in FIGS. 8 and 9, the method for timing correction according to an embodiment of the present disclosure comprises following steps.

Step S401: searching for a spare cell that is functionally consistent with the first normal logic cell in the search range, and determining a target spare cell according to the spare cell.

Search for the (Spare) spare cell that is functionally consistent with the first normal logic cell in the search range, and determine a target spare cell according to the spare cell. Optionally, search for (all) spare cells that is functionally consistent with the cell C within the determined search range, and select the most suitable (Spare) spare cells for correct timing violation as the target spare cell.

Step S402: modifying a wire network connection according to the target spare cell.

Modify the wire network connection according to the target spare cell. Modify wire network connection according to the target spare cell to correct timing violation.

In an alternative embodiment of the present disclosure, figure (a) of FIG. 9 shows the layout with timing violation, figure (b) of FIG. 9 shows a circuit structure of timing violation, figure (c) of FIG. 9 shows the layout after performing timing correction, and figure (d) of FIG. 9 shows a circuit structure after performing timing correction. FIG. 9 shows the ECO operation of logic cell size change by use of a spare cell in the chip layout according to an embodiment of the present disclosure. As shown in FIG. 9, when the timing violation occurs, the path and cell with timing violation are determined. Then search for the (Spare) spare cell and select a (Spare) result cell. Modify wire network connection according to the final (Spare) result cell. For Example, replace the first normal logic cell with the (Spare) result cell.

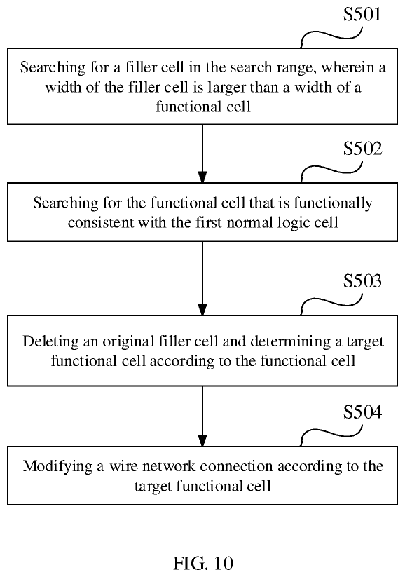

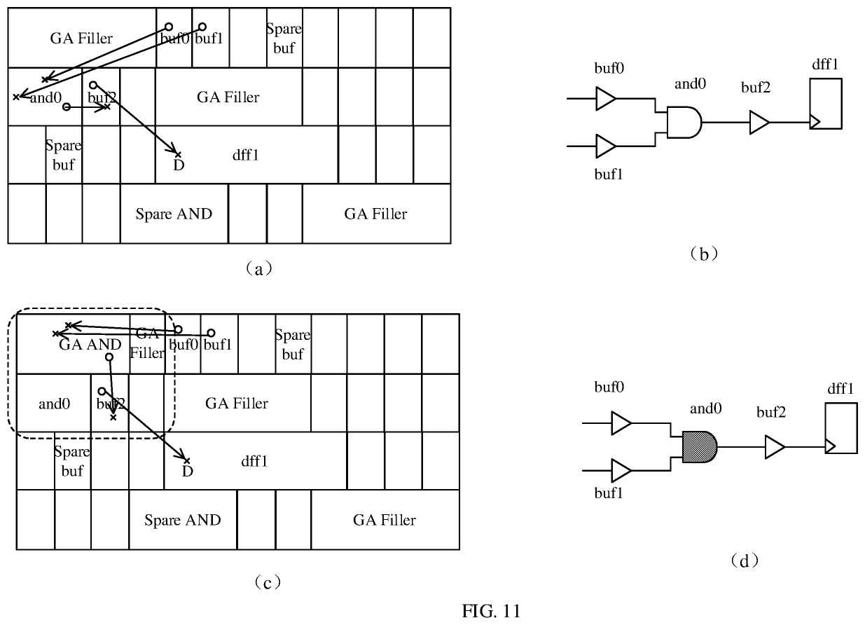

FIG. 10 shows a method flow chart of a method for timing correction according to an embodiment of the present disclosure. FIG. 11 shows a schematic diagram of timing correction according to an embodiment of the present disclosure. As shown in FIG. 10 and FIG. 11, the method for timing correction according to the embodiment of the present disclosure includes following steps.

Step S501: searching for a filler cell in the search range, wherein a width of the filler cell is larger than a width of a functional cell.

Search for the filler cell (GA filler), wherein the width of the filler cell is larger than the width of a functional cell (GA). Optionally, search for the filler cell (GA filler) within the determined search range, the width of the GA filler cells should be larger than the width of the GA functional cell.

Step S502: searching for the functional cell that is functionally consistent with the first normal logic cell.

Search for the GA functional cell that is functionally consistent with the first normal logic cell. Optionally, search for the GA functional cell that is functionally consistent with the first normal logic cell within the determined search range.

Step S503: deleting an original filler cell and determining a target functional cell according to the functional cell.

Delete the original filler cell and determining a target functional cell according to the functional cell. Optionally, the original filler cell (GA filler) is deleted and the GA functional cell most suitable for timing violation correct from the (all) GA functional cells is selected as the GA functional result cell.

Step S504: modifying a wire network connection according to the target functional cell.

Modify the wire network connection according to the target (GA) functional cell. For example, modify the target network connection according to the final GA target functional cell.

In an alternative embodiment of the disclosure, the method for timing correction further includes back-filling at least one filler cell (GA filler) to ensure that no gaps appear on the cell line.

In an alternative embodiment of the present disclosure, figure (a) of FIG. 11 shows the layout with timing violation, figure (b) of FIG. 11 shows a circuit structure of timing violation, figure (c) of FIG. 11 shows the layout after performing timing correction, and figure (d) of FIG. 11 shows a circuit structure after performing timing correction. FIG. 11 shows the ECO operation of logic cell size change by use of a GA AND cell in the chip layout according to an embodiment of the present disclosure. As shown in FIG. 11, when the timing violation occurs, the path and cell with timing violation are determined. Then search for the GA functional cell and select a target functional cell. Modify wire network connection according to the final target functional cell. For Example, replace the first normal logic cell with the target functional cell.

In an alternative embodiment of the disclosure, timing optimization using the (Spare) spare cell is for example achieved by the following algorithm:

| Input: violation pathA, distance range dist parameter | |
|---|---|
| Output: ECO output script | |
| 1: | foreach Combined logic cell C: with C as a center, search for the Spare cell |

C2 having the same function within the dist range

| | |
|---|---|
| 2: | if timing deterioration after replacing cell C with C2 then |
| 3: | continue; |
| 4: | else |
| 5: | Try to change C-> C2, and add C-> C2 to the result set |
| 6: | endif |
| 7: | endfor |
| 8: | Find the Spare buffer cell within the dist range, centered around timing |

violation point

| | |
|---|---|
| 9: | Select the most suitable spare buffer cell for buffer cell insertion operation, |

and add the result set

| | |
|---|---|
| 10: | Perverse through the result set, select the optimization scheme for the |

maximum timing improvement, and select the ECO script for the output line network change

In an alternative embodiment of the disclosure, timing optimization using the GA cell is for example achieved by the following algorithm:

| Input: violation pathA, distance range dist parameter | |
|---|---|
| Output: ECO output script | |
| 1: | foreach Combined logic cell C: With C as the center, search for the GA filler |

F1 within the dist range

| | |
|---|---|
| 2: | if timing deterioration after replacing cell C with the GA functional cell |

C2 that is functionally consistent, then

| | |
|---|---|
| 3: | continue; |
| 4: | else |
| 5: | Try to change C-> C2 and add C-> C2 to the result set |
| 6: | endif |
| 7: | endfor |
| 8: | Find GA filler F1 within dist range, centered around timing violation point |
| 9: | Select the most suitable GA buffer C2 for the buffer cell insertion operation, |

and add the result set

| | |
|---|---|
| 10: | Perverse through the result set, select the optimization scheme for the |

maximum timing improvement, and delete F1, insert C2,

| | |
|---|---|
| | and backfill new GA filler with width equal to width (F1) - width (C2) |
| 11: | The ECO script for the output line network change |

In an alternative embodiment of the disclosure, (Spare) spare cells, GA Filler cells, GA functional cells, etc. all need to be identified by specifying the name pattern of the cell type in the cell library.

In an alternative embodiment of the present disclosure, the method for timing correction includes following steps.

In a first step, determine the name pattern parameter of the cell type in the cell library to identify the (Spare) spare cells, GA cells, etc.: given the dist parameter, to control the search range of the Spark pare cells and GA cells.

In a second step, take violation point A as the center, find the (Spark) spare cells within the Manhattan range of {|X-Xa|<dist, |Y-Ya|<dist}, select the (Spark) spare cells matching the timing adjustment, change the line network connection relationship, and conduct ECO operation of buffer cell insertion.

In a third step, take violation point A as the center, find the wide GA filler within the Manhattan range of {|X-Xa|<dist, |Y-Ya|<dist}, insert the GA buffer matching the timing alignment, change the line network connection relationship, and perform ECO operation of buffer cell insertion. And backfill the gap on the cell row with a GA filler of a small width.

In a fourth step, perverse the combined logic cell C on the timing path, and search for the spare cells functionally consistent with the logic cell C within the Manhattan range of {|X-Xc|<dist, |Y-Yc|<dist}. Select the Spare alternatives matching with the timing adjustment, change the line network connection relationship, and perform the ECO operation of the logic cell size change.

In a fifth step, perverse the combined logic cell C on the timing path, and search for GA fillers with large width within the Manhattan range of {|X-Xc|<dist, |Y-Yc|<dist}. Select the GA functional cell matching with the timing adjustment and functionally consistent with the logic cell C, change the line network connection relationship, and perform the ECO operation of the logic cell size change. And backfill the gap on the cell row with a GA filler of a small width.

It should be noted that above steps are not necessary.

In an alternative embodiment of the present disclosure, the method for timing correction includes following steps;
(1) Do not change the physical layout and the bottom base layer of the cell, only change the metal connection of the upper layer to adjust the timing of the circuit;
(2) Determine the timing path of timing violation, search for the suitable spare cell within the given range, and perform the ECO operation of the buffer cell insertion;
(3) Search for suitable (Spare) spare cell within the given range for ECO operation of logic cell size change;
(4) Determine the timing path of timing violation, search for the suitable GA filler within the given range, perform the ECO operation of buffer cell insertion, and fill in the suitable size GA fillers;
(5) Search for the suitable GA filler within the given range, perform ECO operation of logic cell size change, and fill in the suitable size GA filler.

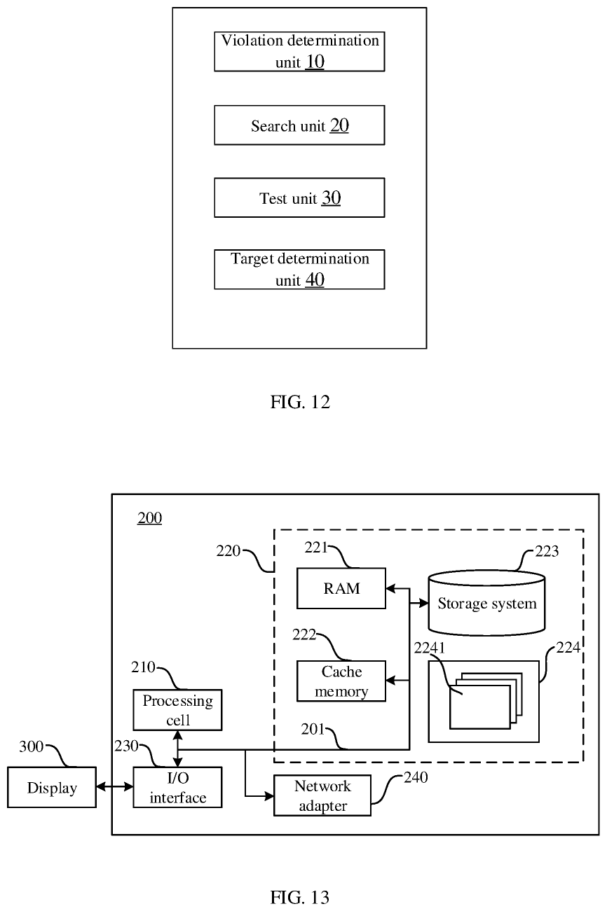

FIG. 12 shows a schematic diagram of a device for timing correction according to an embodiment of the present disclosure. The device for timing correction according to the embodiment of the present disclosure is applied to an integrated circuit including a plurality of normal logic cells and a plurality of spare correction cells. As shown in FIG. 12, the device for timing correction according to the embodiment of the present disclosure includes a violation determination unit 10, a search unit 20, a test unit 30 and a target determination unit 40.

The violation determination unit 10 is configured to determine a timing path with a timing error and a first normal logic cell in the timing path that does not meet a timing requirement in the integrated circuit.

The search unit 20 is configured to set a search range around the first normal logic cell and determining at least one spare correction cell for timing correction within the search range.

The test unit 30 is configured to test one by one and obtaining a timing result of the at least one spare correction cell for timing correction used in the integrated circuit.

The target determination unit 40 is configured to determine a target spare correction cell for timing correction in the integrated circuit according to the timing result, wherein the target spare correction cell is at least one of the at least one spare correction cell for timing correction.

FIG. 13 shows a schematic diagram of a computing device according to an embodiment of the present disclosure. Referring to FIG. 13, the present disclosure further provides a block diagram suitable for implementing an exemplary computing device of an embodiment of the present disclosure. It should be understood that the computing apparatus shown in FIG. 13 is only an example and does not impose any limitation on the function and scope of use of the embodiment of the present disclosure.

As shown in FIG. 13, the computing device 200 is represented in a form of a general-purpose computing device. The components of the computing device 200 may include, but are not limited to, one or more processors or processing cells 210, a memory 220, a bus 201 connecting different system components (including the memory 220 and the processing cell 210).

Bus 201 represents one or more of several types of bus structures, including a memory bus or a memory controller, a peripheral bus, a graphical acceleration port, a processor, or a local bus using any bus structure in a variety of bus structures. For example, these architectures include, but are not limited to, the Industrial Standard Architecture (ISA) bus, Microchannel Architecture (MAC) bus, enhanced ISA bus, video Electronics Standards Association (VESA) local bus, and peripheral component Interconnect (PCI) bus.

The computing device 200 typically includes a variety of computer system-readable media. These media may be any available medium accessible to the computing device 200, including volatile and non-volatile media, mobile and immovable media.

The system memory 220 may include a computer system-readable medium in the form of volatile memory, such as a random-access memory (RAM) 221 and/or a cache memory 222. The computing device 200 may further include other mobile/immovable, volatile/non-volatile computer system storage media. Just as an example, a storage system 223 may be used to read and write immovable, non-volatile magnetic media (FIG. 13 not shown, commonly referred to as a “hard drive”). Although not shown in FIG. 13, a disk drive can read and write a removable non-volatile disk (such as a floppy disk) and read and write a removable non-volatile disk (such as CD-ROM, DVD-ROM, or other optical media). In these cases, each drive may be connected to the bus 201 through one or more data media interfaces. The memory 220 may include at least one program product having a set of (e. g. at least one) program modules that are configured to perform functions of the embodiments of the present disclosure.

A program/utility 224 having a set of (at least one) of program modules 2241 may be stored in, for example, memory 220, such program modules 2241 include but not limited to an operating system, one or more applications, other program modules, and program data, and each or some combination of these examples may include an implementation of a network environment. The program module 2241 generally performs the functions and/or methods described in the embodiments of the present disclosure.

Further, the computing device 200 may also communicate with a display 300 to display results of screening sorting including, but not limited to, a liquid crystal display (LCD), a light emitting diode (LED) display, and a plasma display. In some embodiments, the display 300 may also be a touch screen.

Further, the computing device 200 may also communicate with one or more devices that enable the user to interact with the computing device 200, and/or with any device (e. g., network card, modem, etc.) that enables the computing device 200 to communicate with one or more other computing devices. This communication may be performed through the input/output (I/O) interface 230. Moreover, the computing device 200 may also communicate with one or more networks (e. g., a local area network (LAN), a wide area network (WAN), and/or public networks, such as the Internet) via a network adapter 240. As shown, the network adapter 240 communicates with other modules of the computing device 200 via the bus 201. It should be understood that, although not shown in the figure, other hardware and/or software modules may be used in conjunction with the computing device 200, including, but not limited to, microcode, device drive, redundant processing cell, external disk drive array, RAID system, tape drive, and data backup storage system.

The processing cell 210 performs various functional applications and data processing by running the programs stored in the system memory 220.

According to another aspect of the disclosure, there is provided a computer readable storage medium stored on which is a computer program (or a computer executable instruction) that is used when executed by a processor to execute the method for timing correction provided by the embodiment of the present disclosure, wherein the method includes;

Determining a timing path with a timing error and a first normal logic cell in the timing path that does not meet a timing requirement in the integrated circuit;

Setting a search range around the first normal logic cell and determining at least one spare correction cell for timing correction within the search range;

Testing one by one and obtaining a timing result of the at least one spare correction cell for timing correction used in the integrated circuit;

Determining a target spare correction cell for timing correction in the integrated circuit according to the timing result, wherein the target spare correction cell is at least one of the at least one spare correction cell for timing correction.

The computer storage medium of the embodiment of the present disclosure may employ any combination of one or more computer-readable media. Computer readable medium may be computer readable signal medium or computer readable storage medium. A computer-readable storage medium may be, but not limited to, electric, magnetic, optical, electromagnetic, infrared, or semiconductor system, device or device, or any combination or above. More specific examples of computer-readable storage media (non-exhaustive lists) include electrical connections with one or more wires, portable computer disks, hard disks, random access memory (RAM), read only memory (ROM), erasable programmable read only memory (EPROM or flash), optical fibers, portable compact disk only read only memory (CD-ROM), optical storage, magnetic memory devices, or any of the above. In the present disclosure, a computer-readable storage medium may be any tangible medium containing or storing a program that may be used by or in combination with an instruction execution system, device, or device.

A computer-readable signal medium may comprise data signals propagated in a baseband or as part of a carrier that carries a computer-readable program code. Such propagating data signals may be used in various forms, including but not limited to electromagnetic signals, optical signals or any suitable combination of the above. A computer-readable signal medium may also be any computer-readable medium other than a computer-readable storage medium, transmitting or transmitting programs used by or in combination with an instruction execution system, device or device.

The program code contained on a computer-readable medium may be transmitted with any suitable medium, including but not limited to wireless, wire, optical cable, RF, etc., or any suitable combination of the above.

A computer program code for performing operations of the present embodiment may be written in one or more programming languages or combinations thereof, comprising an object-oriented programming language (such as Java, Smalltalk, C++), and a conventional procedural programming language such as a C or a similar programming language. The program code may be executed completely on a user computer, partially on a user computer, as a separate software package, partially on a remote computer, or completely on a remote computer or computing device. In cases involving a remote computer, a remote computer can be connected to a user's computer via any kind of network including a local area network (LAN) or a wide area network (WAN), or, alternatively, to an external computer (for example, via an Internet connection using an Internet service provider).

It should be noted that in this article, relationship terms such as the first and second classes are used solely to distinguish one entity or operation from another entity or operation, without necessarily requiring or implying the existence of any such actual relationship or order between such entities or operations. Moreover, the term “include”, “comprise” or any other variation intended to cover non-exclusive inclusion, thus including a series of elements of the process, method, items, or equipment include not only those elements, but also other elements not explicitly listed, or also include elements inherent to the process, method, items, or equipment. In the absence of additional restrictions, the elements defined by the statement “include a . . . ” does not exclude the existence of other same elements in the process, method, article, or device including the elements.

According to the embodiment of the present disclosure, e. g. described above, these embodiments do not detail all the details and do not limit the disclosure to only the specific embodiment. Obviously, there are many modifications and changes that can be made based on the above description. The specification selects and describes these embodiments in order to better explain the principle and practical application of the disclosure, so that people skilled in the technical field can make good use of the disclosure and the modification of the disclosure. The present disclosure is limited only by the claim and its full scope and equivalent.

1. A method for timing correction of an integrated circuit, wherein the integrated circuit comprises a plurality of normal logic cells and a plurality of spare correction cells, the method for timing correction comprises:
determining a timing path with a timing error and a first normal logic cell in the timing path that does not meet a timing requirement in the integrated circuit;
setting a search range around the first normal logic cell and determining at least one spare correction cell for timing correction within the search range;
testing one by one and obtaining a timing result of the at least one spare correction cell for timing correction used in the integrated circuit;
determining a target spare correction cell for timing correction in the integrated circuit according to the timing result, wherein the target spare correction cell is at least one of the at least one spare correction cell for timing correction.

2. The method for timing correction according to claim 1, wherein the method for timing correction further comprises:
obtaining a cell type and physical position of the first normal logic cell.

3. The method for timing correction according to claim 1, wherein setting a search range around the first normal logic cell comprises:
setting a distance parameter;
determining that the search range is within a Manhattan distance of the first normal logic cell and the distance parameter.

4. The method for timing correction according to claim 1, wherein the method for timing correction further comprises:
searching for a spare cell in the search range, and determining a target spare cell according to the spare cell;
modifying a wire network connection according to the target spare cell.

5. The method for timing correction according to claim 1, wherein the method for timing correction further comprises:
searching for a filler cell in the search range, wherein a width of the filler cell is larger than a width of a buffer cell;
determining a target buffer cell according to the buffer cell;
modifying a wire network connection according to the target buffer cell,
wherein the method for timing correction further comprises back-filling at least one filler cell.

6. The method for timing correction according to claim 1, wherein setting a search range around the first normal logic cell comprises:
setting a distance parameter;
traversing a combined logic cell on a timing violation path;
determining that the search range is within a Manhattan distance of the combined logic cell and the distance parameter.

7. The method for timing correction according to claim 1, wherein the method for timing correction further comprises:
searching for a spare cell that is functionally consistent with the first normal logic cell in the search range, and determining a target spare cell according to the spare cell;
modifying a wire network connection according to the target spare cell.

8. The method for timing correction according to claim 1, wherein the method for timing correction further comprises:
searching for a filler cell in the search range, wherein a width of the filler cell is larger than a width of a functional cell;
searching for the functional cell that is functionally consistent with the first normal logic cell;
deleting an original filler cell and determining a target functional cell according to the functional cell;
modifying a wire network connection according to the target functional cell,
wherein the method for timing correction further comprises back-filling at least one filler cell.

9. A device for timing correction of an integrated circuit, wherein the integrated circuit comprises a plurality of normal logic cells and a plurality of spare correction cells, the method for timing correction comprises:
a violation determination unit for determining a timing path with a timing error and a first normal logic cell in the timing path that does not meet a timing requirement in the integrated circuit;
a search unit for setting a search range around the first normal logic cell and determining at least one spare correction cell for timing correction within the search range;
a test unit for testing one by one and obtaining a timing result of the at least one spare correction cell for timing correction used in the integrated circuit;
a target determination unit for determining a target spare correction cell for timing correction in the integrated circuit according to the timing result, wherein the target spare correction cell is at least one of the at least one spare correction cell for timing correction.

10. A computing device comprising:
a processor;
a memory for storing one or more programs,
wherein, when the one or more programs are executed by the processor, the processor performs the method for timing correction of claim 1.

11. (canceled)
